(19) United States
(12) Patent Application Publication
(10) Pub. No.: US 2006/0165245 A1
(43) Pub. Date: Jul. 27, 2006

(54) Installation for controlling aids for public functions

(75) Inventors: Wolfgang Niehoff, Wedemark (DE); Axel Haupt, Langenhagen (DE)

Correspondence Address: Michael B. Lasky;Altera Law Group, Suite 100, 6500 City West Parkway, Minneapolis, MN, 55344-7704, US

(73) Assignee: Sennheiser Electronic GMBH & Co.

(21) Appl. No.: 11/393,275

(22) Filed: Mar. 30, 2006

Related U.S. Application Data
(63) Continuation of application No. 09/706,585, filed on Nov. 3, 2000.

(30) Foreign Application Priority Data
Nov. 4, 1999 (DE) 199 53 003.3

(51) Int. Cl. H04R 27/00

(52) U.S. Cl. 381/82

(57) ABSTRACT

The invention provides an installation for controlling aids (8, 9, 10, 12) for public functions, in particular sound irradiation and/or illumination systems. The installation comprises a control unit. At least one mobile object, in particular an (audio) signal source, as well as one or more aids to be controlled, can be connected to the control unit. The installation comprises control means for controlling the aids. Provided in the installation is a locating device for locating a relevant position, for instance the position of an actor, which outputs a position signal indicating the relevant position to the control unit. Moreover, the control unit controls the aid or aids (8, 9, 10, 12) in dependence on the position signal.

The invention relates to an installation for controlling aids for public functions, in particular acoustic irradiation and/or illumination systems, having a control unit to which at least one movable object, in particular an (audio) signal source, as well as one or more aids to be controlled can be connected, and comprises the control means for controlling the aids.

Installations of the above type are known. A known installation is constructed as a mixing console and disposed in a performance area comprising a stage area as well as a public area. The performance area has a closed construction, for instance like a congress hall, or in the open air, for instance as a stadium. The mixing console serves to control an acoustic irradiation installation which amplifies one or more audio signals from an (audio) signal source and fills the public area and also, where appropriate, the stage area with the amplified audio signal. The acoustic irradiation is performed by means of several loudspeakers of the acoustic irradiation installation which are provided in the performance area. The loudspeakers are each disposed in such a manner that they radiate the amplified audio signal in particular into a predeterminate section of the public area and/or of the stage area.

The amplitude of the amplified audio signal can be adjusted by means of the mixing console. The mixing console is provided for operation by a sound engineer. The sound engineer performs the adjustment of the amplitude in accordance with each situation on the stage which he observes in such a manner that the overall impression in the performance area, in particular in the public area, which is produced by audio signals radiated by all the loudspeakers, is complementary to the situation in the stage area. The amplified audio signal is suppled to each loudspeaker from the mixing console.

In addition, in the known installation a control of one or more spotlights is provided. The spotlight is disposed in the performance area in such a manner that it can throw a cone of light in a narrow dihedral angle in the stage area. The spotlight is rotatably mounted around a vertical axis and a horizontal axis and the dihedral angle that can be radiated can be adjusted by a lighting engineer. Depending on the situation in the stage area, for instance the position of an actor on the stage, the alignment of the spotlight is performed by the lighting engineer in such a manner, for instance, that the dihedral angle radiated from the spotlight hits the actor.

The known installation consequently requires the attentiveness of the staff operating the control unit, i.e. of the sound engineer at the mixing console and of the lighting engineer at the spotlight, so that the control of the loudspeakers and of the spotlight is performed according to the situation in the stage area.

The object of the invention is to develop further an installation of the type mentioned at the beginning so that the control of the aids is rationalised.

This object is achieved in accordance with the invention with the installation of the type mentioned at the beginning in that a locating device for locating a relevant position, for instance the position of an actor is provided, which outputs a position signal indicating the relevant position to the control unit and in that the control unit controls the aid or aids in dependence on the position signal.

With the invention one obtains an installation by means of which the aids can be controlled in a particularly rational manner. The position signal outputted by the locating device simplifies the operation of the installation because only a small degree of attentiveness is required by the operator to adjust the control unit according to the situation in the stage area.

So that the control unit controls the aids in dependence on the position signal, control functions determining the interaction can be preset in the device. A control operation is repeatable according to the predetermined control function. With the installation specified by the invention a higher degree of precision can be achieved in the control of the aids according to the respectively predetermined control function than with manual control.

The locating device of the installation according to the invention preferably has fixed radio beacon transmitters to be arranged spaced from one another for transmitting radio beacon signals. The fixed radio beacon signals are to be disposed in the performance area. In a further development of this embodiment, the position of the radio beacon transmitter can be inputted into a memory unit of the radio beacon transmitter. Moreover, the positions of the fixed radio beacon transmitters, where appropriate the spacing of the radio beacon transmitters as well as positions and other data relating to other relevant objects in the stage area and/or public area can be stored in a memory unit of the control unit. The radio beacon transmitter transmits a signal containing an item of information on the position of the radio beacon transmitter.

The locating device has a mobile receiver for receiving the radio beacon signals and an output unit which derives the position signal from the received radio beacon signals and outputs it. The fixed radio beacon transmitters are preferably constructed as high-frequency transmitters and the mobile receiver is accordingly constructed as a high-frequency receiver.

To output the position signal to the control unit a mobile transmitter is provided, with which a receiver of the control unit is associated.

The position of the mobile receiver of the radio beacon signals may preferably be determined by means of the radio beacon signals transmitted from the radio beacon transmitters. In one embodiment this determination is performed in accordance with the so-called triangle process or another process which is known to a person skilled in the art for locating systems. The received radio beacon signals are placed in relationship or linked with one another.

In a particularly preferred embodiment of the invention, the respective position of each receiver can be determined by means of several receivers, possibly independent of one another, and can be outputted to the control unit.

In accordance with another preferred embodiment of the invention, the fixed radio beacon transmitters transmit the radio beacon signals in the GPS format and the mobile receiver is constructed as a GPS receiver. The GPS receiver is simple and cheap to produce or obtain from commercially available structural elements.

The mobile transmitter is preferably constructed as a high-frequency transmitter and the associated receiver accordingly as a high-frequency receiver. In this embodiment the mobile transmitter can be carried in a particularly simple manner, for instance by an actor, without the freedom of movement of the actor being restricted, for instance by a connecting cable. Moreover, this embodiment does not subject the actor to the restriction of there having to be a free view between transmitter and receiver, as is required in an infrared system, for instance.

The control unit may preferably receive derived position signals from several locating devices and process them. This embodiment of the invention is quite particularly suitable for performances in which the locating device is provided to determine several relevant positions. The mobile receivers each located at one of the relevant positions are each associated with a mobile high-frequency transmitter, which transmits the position signal in an individual carrier frequency and/or provided with an individual identification. The high-frequency receivers of the control unit are tuned to the high-frequency transmitter, so that they can receive them on the transmitting frequency. In this embodiment of the invention the control of the aids is possible in dependence on several relevant positions.

In accordance with another particularly preferred embodiment of the invention, the mobile receiver, the output unit and the mobile transmitter are constructed as a portable compact appliance. The portable compact appliance is worn, for instance, on the actor's body or in a pocket in the clothing of the actor.

The (audio) signal source of the installation specified by the invention may be constructed as a microphone. In this case the mobile receiver, the output unit and the mobile transmitter are preferably disposed in the housing of the microphone. This has the advantage that where appropriate the transmitter for transmitting the audio signal and the mobile transmitter for transmitting the position signal can be combined in one functional unit. Moreover, the energy supply can be taken from a common source, such as a battery disposed in the housing of the microphone.

In an alternative embodiment of the invention, a mobile transmitter is provided and fixed receiving beacons are provided to receive the signal transmitted from the mobile transmitter. The signal transmitted from the mobile transmitter is received by the fixed receiving beacons as a received signal. A position signal with an item of information relating to the position of the mobile transmitter can be determined from the large number of received signals.

Finally a microphone, in particular for use at a public function, with an electroacoustic transducer for receiving an audio signal in a transmitter for transmitting an audio signal, and with a locating device as specified by the invention.

An exemplified embodiment of the invention is explained in further detail below by means of the drawings.

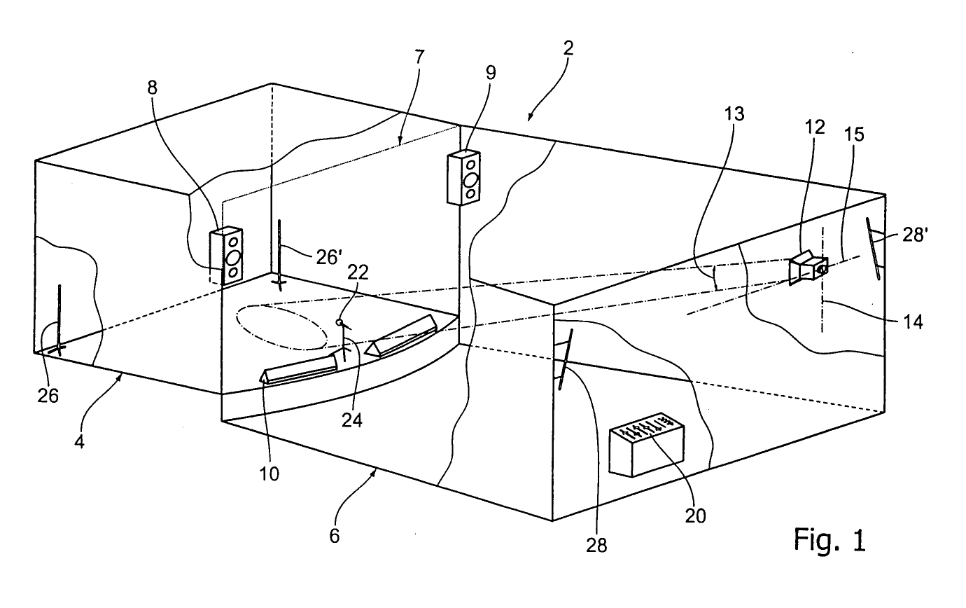

FIG. 1 shows as a diagrammatical model a perspective view of a performance area in which aids are disposed, which are actuated by an installation according to the invention;

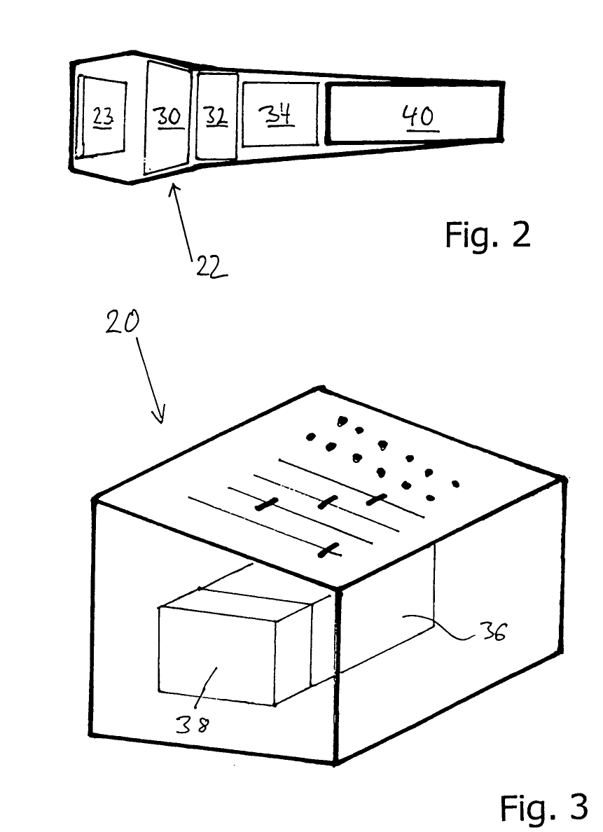

FIG. 2 shows a diagrammatical representation of a longitudinal section through a microphone; and

FIG. 3 shows a diagrammatical representation of a mixing console.

The performance area 2 represented in FIG. 1 comprises a stage area 4 and a public area 6, which are separated from one another at a boundary surface 7. A left loudspeaker 8 and a right loudspeaker 9 are disposed in the region of the boundary surface 7 in such a manner that they fill the public area 6 in particular with sound. Furthermore, a monitor loudspeaker 10 is also provided in the region of the boundary surface 7 in such a manner that it fills the stage area 4 in particular with sound.

Moreover, disposed in the public area 6 is a spotlight 12, which throws a cone of light in a narrow dihedral angle 13 and in particular beams into the stage area 4. The spotlight 12 is movably constructed around a vertical axis 14 and a horizontal axis 15. Drives (not represented), which achieve remote-controlled adjustability by turning the spotlight 12 around the axes 14 and 15, are provided on the spotlight 12. Further operable aids, such as, for example, mobile stage parts and/or special effects devices, can be disposed in the performance area.

A control unit constructed as a mixing console 20 is disposed in the public area 6 in a region lying opposite the boundary surface 7. The mixing console 20 is connected to an amplifying facility (not represented), which serves to amplify audio signals. The mixing console 20 comprises regulators to regulate the amplitude of amplified audio signals. The left loudspeaker 8, the right loudspeaker 9 and the monitor loudspeaker 10 are connected to the mixing console 20. Amplified and regulated audio signals can be outputted from the mixing console 20 to the loudspeakers 8, 9, 10.

A mobile microphone 22 is disposed in the stage area 4. The microphone is detachably fixed to a stand 24 and can be released from the stand 24 by a person in the stage area 4, for instance an actor, and be carried through the stage area 4. In this case the freedom of movement of the actor carrying the microphone 22 is not restricted by a connecting cable to the amplifying facility; the microphone 22 is in fact equipped with a high-frequency transmitter 34 which transmits an audio signal which is provided to be received by a high-frequency receiver at the amplifying facility.

Disposed in the performance area 2 are four radio beacon transmitters 26, 26′, 28, 28′ in such a manner that they are spaced in pairs approximately at the maximum distance apart. Additional radio beacon transmitters can be disposed in the performance area 2 in order to increase the efficiency of the locating device. The arrangement of the radio beacon transmitters 26, 26′, 28, 28′ is fixed at least for the period of a performance. Two radio beacon transmitters 26, 26′ are disposed in the stage area 4 opposite the boundary surface 7; two further radio beacon transmitters 28, 28′ are disposed in the public area 6 opposite the boundary surface 7. The radio beacon transmitters are connected to the mixing console 20 in order to coordinate the transmitted signals centrally in a suitable manner. The position of the radio beacon transmitters 26, 26′, 28, 28′ is stored in a memory device of the mixing console 20. The radio beacon transmitters 26, 26′, 28, 28′, transmit a high-frequency signal in the GPS format, which amongst other things contains an item of information regarding the position of the respective radio beacon transmitter 26, 26′, 28, 28′.

The microphone 22 represented in FIG. 2 comprises an electroacoustic transducer 23. Disposed in the housing of the microphone 22 is a GPS receiver 30, which is provided to receive the signals transmitted from the radio beacon transmitters 26, 26′, 28, 28′. An output unit 32 for determining and outputting a position signal derived from the radio beacon signals is also disposed in the housing of the microphone 22. An accumulator for energy supply can be inserted in a battery compartment 40. The output unit 32 delivers the position signal to the high-frequency transmitter 34 of the microphone 22 which transmits the position signal. The transmitted position signal is received by the high-frequency receiver of the amplifying facility (not represented) and is transmitted to the mixing console 20.

A data processing system 36 with a memory unit 38 is disposed in the mixing console 20 represented in FIG. 3. The data processing system 36 determines from the position signal—preferably for three dimensions—the positional data of the GPS receiver 30 of the microphone 22. The data processing system 36 performs a control function program stored in the memory unit 38. By using the positional data as parameters, the control function program 36 outputs a first group of control values, which serve to regulate the amplitude of the amplified audio signals delivered by the loudspeakers 8, 9, 10. In accordance with a determined control function program, the amplitude of the audio signal outputted from the left loudspeaker 8 is regulated to be larger than the amplitude of the audio signal outputted from the right loudspeaker 9 when the GPS receiver 30 of the microphone 22 is closer to the left loudspeaker 8 than to the right loudspeaker 9. The amplitude of the audio signal delivered by the monitor loudspeaker 10 is regulated to be louder if the GPS receiver 30 is removed from the monitor loudspeaker 10. The position of the GPS receiver 30 corresponds to that of the microphone 22 and, for instance, also to the position of the actor because the GPS receiver 30 is disposed in the housing of the microphone 22.

Moreover, the control function program outputs a second group of control values, which serve to actuate the drives (not represented) for the rotation of the spotlight 12 around the vertical and the horizontal axes 14 and 15 respectively. The spotlight 12 is aligned in accordance with a determined control function program so that the centre axis of the dihedral angle 13 of the cone of light intersects the position of the GPS receiver 30 in the housing of the microphone 22 and the actor is illuminated in the cone of light of the spotlight 12.

1-11. (canceled)

12. An installation for controlling an acoustic illumination system, comprising:
a first audio signal source with a first location, wherein the first audio signal source is
a microphone producing a first audio signal;
a first locating device attached to the first audio signal source, wherein the first locating device produces a first position signal in response to the first location of the first audio signal source, wherein the first position signal and the first audio signal are transmitted from the same microphone housing; and
a control unit that receives the first position signal and controls a sound irradiation system in response to the first position signal;
wherein an acoustic impression created by the sound irradiation system essentially corresponds to the first location of the first audio signal source.

13. The installation of claim 12, further comprising:
a plurality of fixed radio beacon transmitters spaced apart from each other, wherein the fixed radio beacon transmitters transmit radio beacon signals.

14. The installation of claim 13, wherein the first locating device comprises a mobile receiver, wherein the mobile receiver receives the radio beacon signals.

15. The installation of claim 14, wherein the fixed radio beacon transmitters are high-frequency transmitters, and wherein the mobile receiver is a high-frequency receiver.

16. The installation of claim 14, wherein the fixed radio beacon transmitters transmit in the GPS format, and wherein the mobile receiver is a GPS receiver.

17. The installation of claim 14, wherein the first locating device further comprises an output unit, wherein the output unit derives the first position signal from the received radio beacon signals, and wherein the output unit outputs the first position signal.

18. The installation of claim 17, wherein the first locating device further comprises a mobile transmitter, wherein the mobile transmitter transmits the first position signal to the control unit.

19. The installation of claim 18, wherein the first locating device is located in a portable compact appliance.

20. The installation of claim 18, wherein the first locating device is located in the microphone.

21. The installation of claim 12, further comprising:
a second audio signal source with a second location; and
a second locating device attached to the second audio signal source, wherein the second locating device produces a second position signal in response to the second location of the second audio signal source; wherein
the control unit receives the second position signal and controls the sound irradiation system also in response to the second position signal; and wherein
an acoustic impression created by the sound irradiation system essentially corresponds also to the second location of the second audio signal source.

22. A wireless position transmitting microphone comprising:
an electronic transducer for receiving a first audio signal;
a receiver to detecting microphone location including a first locating device for producing a first position signal in response to a first location of the microphone,
a transmitter for transmitting the first audio signal as well as the first position signal.

23. An installation for controlling an acoustic illumination system, comprising:
a first audio signal source with a first location, wherein the first audio signal source is a wireless microphone producing a first audio signal having a sound transmitter therein;
a first position determining device attached to wireless microphone , wherein the first locating device produces a first position signal in response to the first location of the first audio signal source, wherein the first position signal and the first audio signal are transmitted from the wireless microphone; and
a control unit that receives the first position signal and controls a sound irradiation system in response to the first position signal;
whereby an acoustic impression created by the sound irradiation system may track the first location of the first audio signal source.
